(19) United States
(12) Patent Application Publication
(10) Pub. No.: US 2014/0360154 A1
(43) Pub. Date: Dec. 11, 2014

(54) GAS TURBINE PLANT HAVING EXHAUST GAS RECIRCULATION

(71) Applicant: ALSTOM Technology Ltd, Baden (CH)

(72) Inventors: Eribert BENZ, Birmenstorf (CH); Frank Graf, Nussbaumen (CH)

(21) Appl. No.: 14/467,591

(22) Filed: Aug. 25, 2014

Related U.S. Application Data
(63) Continuation of application No. PCT/EP2013/054036, filed on Feb. 28, 2013.

(30) Foreign Application Priority Data
Feb. 29, 2012 (CH) 00274/12

(51) Int. Cl. F02C 1/06; F02C 7/08; F02C 3/34

(52) U.S. Cl. CPC F02C 1/06; F02C 3/34; F02C 7/08; F05D 2260/207; F05D 2260/213
USPC 60/39.52

(57) ABSTRACT

The invention relates to a gas turbine plant, including a gas turbine device, which has a compressor and at least one burner and at least one gas turbine, a waste heat boiler assembly, which has a boiler inlet side connected to a turbine outlet and a first boiler outlet connected to a flue and a second boiler outlet, and an exhaust gas recirculation, which connects the second boiler outlet to a compressor inlet. A simplified structure can be achieved in that the waste heat boiler assembly has a first boiler exhaust gas path, which is connected to the boiler inlet side and leads to the first boiler outlet, and that the waste heat boiler assembly has a second boiler exhaust gas path, which is connected to the boiler inlet side and leads to the second boiler outlet separately from the first boiler exhaust gas path.

### CROSS-REFERENCE TO RELATED APPLICATIONS

This application claims priority to PCT/EP2013/054036 filed Feb. 28, 2013, which claims priority to Swiss application 00274/12 filed Feb. 29, 2012, both of which are hereby incorporated in their entireties.

### TECHNICAL FIELD

The present disclosure relates to a waste heat boiler and exhaust gas recirculation.

### BACKGROUND

A gas turbine plant, which comprises a gas turbine installation, a waste heat boiler and an exhaust gas recirculation duct, is known from US 2009/0284013 A1. The gas turbine installation has a compressor for air, a compressor for recirculated exhaust gas, a burner and a gas turbine. The waste heat boiler comprises a boiler inlet side connected to a turbine exhaust of the gas turbine installation, a first boiler outlet connected to an exhaust stack, and a second boiler outlet. The exhaust gas recirculation duct at the moment connects the second boiler outlet to a compressor inlet of the gas turbine installation. In the case of the known gas turbine plant, the recirculated exhaust gas is compressed in a separate compressor. In addition, an exhaust gas aftertreatment device in the form of a three-way catalyst is arranged in the known gas turbine plant upstream of the waste heat boiler.

Another gas turbine plant with exhaust gas recirculation is known from WO 2008/155242 A1, in which the exhaust gas recirculation duct connects a flow splitter to a compressor inlet. In this case, the flow splitter is arranged downstream of a waste heat boiler and enables a controllable apportioning of the overall exhaust gas flow to a partial flow which leads to an exhaust stack and to a partial flow which is recirculated to the compressor by means of the exhaust gas recirculation duct.

### SUMMARY

The present disclosure deals with the problem of specifying an improved embodiment, or at least an alternative embodiment, for a gas turbine plant of the type referred to in the introduction which is especially distinguished by it being able to be realized more cost-effectively and/or by having improved pollutant emissions values.

The disclosure is based on the general idea of using a waste heat boiler assembly which has two boiler exhaust gas paths which are at least partially separated from each other, wherein a first boiler exhaust gas path leads from the boiler inlet side to the first boiler outlet, whereas a second boiler exhaust gas path leads from the boiler inlet side to the second boiler outlet. Therefore, the exhaust gas which is intended for the exhaust stack follows the first boiler exhaust gas path, whereas the exhaust gas which is intended for the exhaust gas recirculation duct follows the second boiler exhaust gas path. By providing boiler exhaust gas paths which are separated from each other inside the same waste heat boiler assembly, it is possible, for example, to specifically design the throughflow resistance of the first boiler exhaust gas path so that the desired exhaust gas recirculation rate is adjusted virtually automatically by means of the second boiler exhaust gas path without additional measures being necessary for propelling the exhaust gas which is to be recirculated. For example, the flow-passable cross section of the first boiler exhaust gas path can be of smaller design than the flow-passable cross section of the second boiler exhaust gas path in such a way that the desired exhaust gas recirculation rate is established.

For example, it can be provided according to an advantageous embodiment that a boiler partition is arranged in the waste heat boiler assembly and separates the two boiler exhaust gas paths from each other. Such a boiler partition can be realized particularly easily in the respective waste heat boiler. In addition, the boiler partition can undertake additional tasks, such as a support function for additional components of the waste heat boiler. For example, the boiler partition can serve for the fastening of tubes or pipes of a heat exchanger assembly.

According to another advantageous embodiment, the boiler inlet side can have a common boiler inlet from which extends a common boiler main path which at a distance from the boiler inlet side branches at a boiler branch point into the two boiler exhaust gas paths. In other words, the two separate boiler exhaust gas paths do not extend through the entire waste heat boiler assembly but only through one section of the waste heat boiler assembly which leads to the two boiler outlets. As a result of this, the apportioning of the overall exhaust gas flow to the two boiler exhaust gas paths inside the waste heat boiler assembly can especially be realized. Aerodynamically favorable flow conditions, for example, can consequently be created.

According to an advantageous development, a control element can be arranged at the aforementioned boiler branch point, by means of which an apportioning of the exhaust gas flow to the two boiler exhaust gas paths can be controlled. By means of such a control element, the exhaust gas recirculation rate can therefore be adjusted during the operation of the gas turbine plant, for example in order to adapt the exhaust gas recirculation rate to changing operating conditions of the respective gas turbine installation. The locating of the control element in the waste heat boiler assembly is of particular advantage in this case since comparatively large flow cross sections are provided inside the waste heat boiler assembly, as a result of which the prevailing flow velocities are comparatively low. Consequently, the flow forces which act on such a control element are also correspondingly reduced. This simplifies the realization of an adequately stable control element.

In another advantageous embodiment, the boiler inlet side can have a first boiler inlet and a second boiler outlet, wherein the first boiler exhaust gas path then leads from the first boiler inlet to the first boiler outlet, whereas the second boiler exhaust gas path leads from the second boiler inlet to the second boiler outlet separately from the first boiler exhaust gas path. In other words, the two boiler exhaust gas paths are routed separately from the boiler inlet side to the boiler outlet side in the waste heat boiler assembly so that they connect two boiler inlets which are separate from each other to two boiler outlets which are separate from each other.

Additionally or alternatively, provision may expediently be made for a diffuser which is arranged on the boiler inlet side and characterized in that it has a flow-passage cross section which increases in the direction of flow. In the diffuser, therefore, the flow-passable cross section increases, whereas the flow velocity decreases at the same time. The diffuser is therefore arranged between the waste heat boiler assembly and the turbine exhaust.

Of particular advantage is now an embodiment in which the diffuser has a diffuser inlet which is connected to the turbine exhaust, a first diffuser outlet which is connected to the aforementioned first boiler inlet, and a second diffuser outlet which is connected to the aforementioned second boiler inlet. A common diffuser main path, which at a diffuser branch point splits into two separate diffuser exhaust gas paths, then extends from the diffuser inlet. In this way, the dividing of the exhaust gas flow into the first partial flow which is intended for the exhaust stack and the second partial flow which is intended for the exhaust gas recirculation duct is already carried out inside the diffuser, which is seen as being advantageous from the aerodynamic point of view. Such an embodiment can be realized in a particularly cost-effective manner since sufficient space is made available in the diffuser in order to realize the desired separate diffuser exhaust gas paths.

According to an advantageous development, a diffuser partition can be arranged in the diffuser or in a diffuser housing, the inflow edge of which forms the aforementioned diffuser branch point and which separates the two diffuser gas paths up to the diffuser outlets. Such a diffuser partition can be used for stiffening the diffuser housing, for example, as a result of which the diffuser housing can be realized in a simpler manner with adequate stability.

Of particular advantage is now a development in which an outflow edge of the diffuser partition and an inflow edge of the aforementioned boiler partition butt against each other. As a result of this, the separated exhaust gas flow initiated in the diffuser at the diffuser branch point is routed by means of the two diffuser exhaust gas paths through the waste heat boiler assembly via the two boiler exhaust gas paths without a break.

According to another advantageous development, a control element can be arranged at the aforementioned diffuser branch point, by means of which an apportioning of the exhaust gas flow to the two diffuser exhaust gas paths can be controlled. Sufficient installation space is made available in the diffuser, as a result of which the location of such a control element in the diffuser can be realized in a particularly simple manner.

According to another advantageous embodiment, the waste heat boiler assembly can have a heat exchanger assembly for cooling the exhaust gas, wherein the two boiler exhaust gas paths are subjected separately and in parallel to a throughflow of exhaust gas and are routed through the heat exchanger assembly. The cooling of the first exhaust gas partial flow which is fed to the exhaust stack leads to a utilization of the waste heat still contained within the exhaust gas before the exhaust gas partial flow is released into the environment. The cooling of the second exhaust gas partial flow which serves for exhaust gas recirculation can also serve for utilization of the heat contained within the exhaust gas. It leads further to a reduction of the compressor inlet temperature. Also, the cooling of the recirculated exhaust gas can bring about a reduction of the NOₓ emissions.

According to another advantageous embodiment, it can be provided that in the waste heat boiler assembly at least one exhaust gas treatment device is arranged only in the first boiler exhaust gas path. In other words, no exhaust gas treatment device is arranged in the second boiler exhaust gas path. If the aforementioned diffuser exhaust gas paths are to be added, the same applies, so that at least one exhaust gas treatment device is arranged only in the arrangement consisting of first diffuser gas path and first boiler exhaust gas path, whereas no exhaust gas treatment device is arranged in the arrangement consisting of second diffuser exhaust gas path and second boiler exhaust gas path. Exhaust gas treatment devices are predominantly catalysts and particulate filters. Catalysts, which can be used as the exhaust gas treatment device in the first boiler exhaust gas path or alternatively in the first diffuser exhaust gas path, are, for example, a NOₓ catalyst, a CO catalyst, an SCR catalyst or an NSCR catalyst. In this case, SCR stands for “selective catalytic reduction”, whereas NSCR stands for “non-selective catalytic reduction”. The equipping of only the first boiler exhaust gas path or the first diffuser exhaust gas path with at least one exhaust gas aftertreatment device is based on the consideration that only exhaust gas which is routed through the first exhaust gas path makes its way to the exhaust stack and is therefore ultimately emitted into the environment, whereas the exhaust gas which follows the second exhaust gas path is re-supplied to the combustion. Consequently, exhaust gas treatment of the recirculated exhaust gas is unnecessary. This consideration now leads to the respective exhaust gas treatment device having to be designed only for a reduced exhaust gas flow, as a result of which the costs for realization of the exhaust gas treatment can be reduced. At the same time, by locating the respective exhaust gas treatment device in the first boiler exhaust gas path, the flow resistance in the first boiler exhaust gas path compared with the second boiler exhaust gas path can be increased comparatively simply and without additional measures, as result of which the desired exhaust gas apportioning to the exhaust gas recirculation duct, that is to say the desired exhaust gas recirculation rate, can be realized in a comparatively simple manner.

According to another advantageous embodiment, the waste heat boiler assembly can have a common waste heat boiler, in which are formed the two boiler exhaust gas paths and which has the respective boiler inlet and the respective boiler outlet. This embodiment can be realized in an especially simple manner since, for example, use can be made of a conventional waste heat boiler in which by installing a boiler partition the two boiler exhaust gas paths can be formed.

According to an expedient development, the common waste heat boiler can have a common heat exchanger assembly through which both boiler exhaust gas paths are routed. Also in this case, it is possible in principle to use a conventional waste heat boiler in which by putting in a boiler partition the two boiler exhaust gas paths are realized. As a result, a particularly simple and cost-effective realizability ensues. The two boiler waste exhaust gas paths are expediently separated from each other and routed in parallel through the common heat exchanger assembly.

According to an alternative embodiment, the waste heat boiler assembly can have a first waste heat boiler, in which is formed the first boiler exhaust gas path, and a second waste heat boiler, in which is formed the second boiler exhaust gas path. By the provision of two separate waste heat boilers, the two waste heat boilers can be adapted better to the required volumetric flows in each case. However, the constructional cost is greater than in the case of an embodiment with a common waste heat boiler.

According to an expedient development, the heat exchanger assembly can have a first heat exchanger arranged in the first waste heat boiler and a second heat exchanger arranged in the second waste heat boiler, wherein the first boiler exhaust gas path is routed through the first heat exchanger, whereas the second boiler exhaust gas path is routed through the second heat exchanger. Therefore, two separate heat exchangers are made available in order to separately cool the exhaust gas flows which are conducted separately in the two exhaust gas paths. The temperatures of the two exhaust gas flows can especially be adjusted separately as a result.

The two separate waste heat boilers can be accommodated in this case in separate housings or, alternatively, in a common housing. An embodiment in which the first boiler exhaust gas path leading to the exhaust stack extends in an inclined manner in its entirety or at least in one section leading to the exhaust stack in relation to the second boiler exhaust gas path, preferably by approximately 90°, can also be expedient. In this way, existing installation spaces can be considerably better utilized.

In another advantageous embodiment, the first boiler outlet can also be connected to an exhaust gas aftertreatment facility. In other words, in this embodiment at least one exhaust gas aftertreatment facility can be arranged downstream of the waste heat boiler assembly in addition to or alternatively to the at least one exhaust gas treatment device which is provided in the waste heat boiler assembly. Such an exhaust gas aftertreatment facility is, for example, a CCS system, wherein CCS stands for carbon capture and storage. By the same token, other exhaust gas aftertreatment facilities can also be provided. Provision can now expediently be made for an exhaust gas control element by means of which an apportioning of the exhaust gas flow of the second boiler exhaust gas path to the exhaust gas aftertreatment facility and to the exhaust stack can be controlled. In this way, the first exhaust gas partial flow which is assigned to the exhaust stack can be partially or entirely directed through the exhaust gas aftertreatment facility as required. By the same token, bypassing of the exhaust gas aftertreatment facility through the exhaust stack can basically be established.

The exhaust gas recirculation duct can be equipped according to an advantageous embodiment with an additional cooling device which can be designed as a DCC device, for example, wherein DCC stands for “direction contact cooler”. Such a DCC device at the same time enables cooling and scrubbing of the recirculated exhaust gas.

Further important features and advantages are to be gathered from the dependent claims, from the drawings and from the associated figure description with reference to the drawings.

It is understood that the aforementioned features and the features which are still be explained below are applicable not only in the respectively specified combination but also in other combinations or in isolation without departing from the scope of the present disclosure.

### BRIEF DESCRIPTION OF THE DRAWINGS

Preferred exemplary embodiments are represented in the drawings and are explained in more detail in the following description, wherein the same designations refer to the same or similar or functionally the same components.

In the drawing, schematically in each case,

FIGS. 1 and 2 show greatly simplified, schematic diagram-like side views of a gas turbine plant in different embodiments,

FIGS. 3 to 5 show greatly simplified, schematic diagram-like plan views of the gas turbine plant in further, different embodiments.

### DETAILED DESCRIPTION

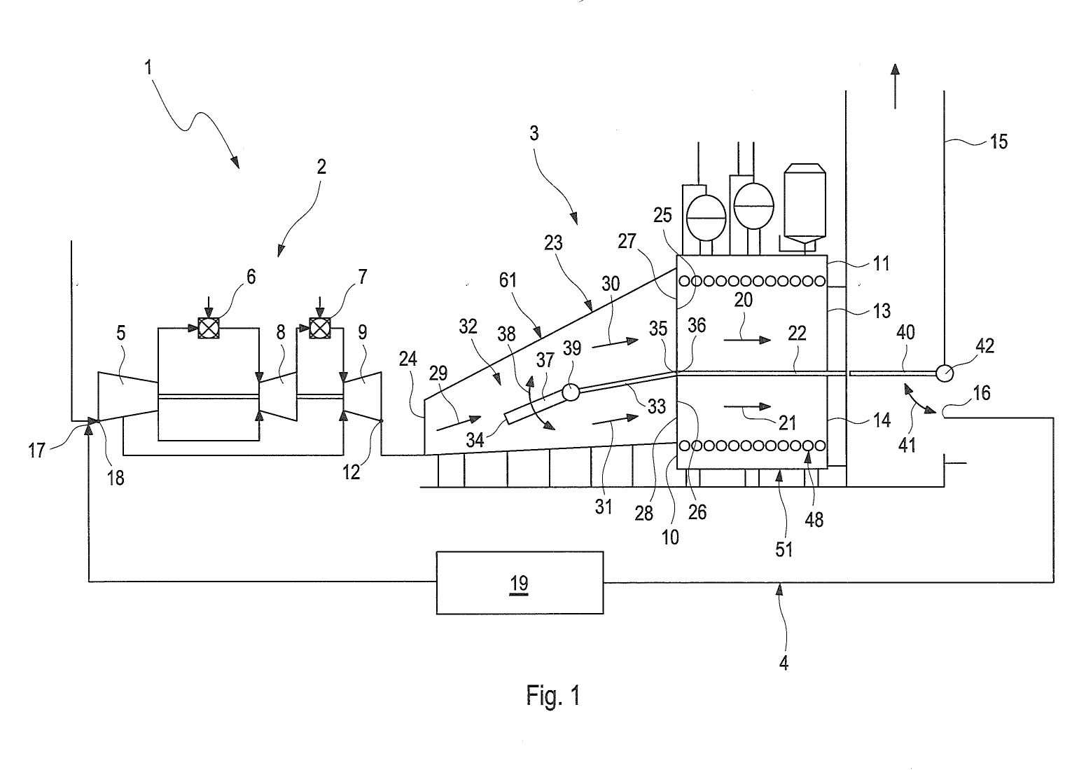

According to FIGS. 1 to 5, a gas turbine plant 1, which can be used in a power plant for power generation, for example, comprises at least one gas turbine installation 2, at least one waste heat boiler assembly 3 and at least one exhaust gas recirculation duct 4. The respective gas turbine installation 2 comprises at least one compressor 5, at least one burner 6 or 7 and at least one gas turbine 8 or 9. In the case of the embodiments shown here, the gas turbine installation 2 comprises two gas turbines 8 and 9 in each case, specifically a high-pressure gas turbine 8 and a low-pressure gas turbine 9. Consequently, two burners 6 and 7 are also provided, specifically a high-pressure burner 6 connected upstream to the high-pressure gas turbine 8 and a low-pressure burner 7 connected upstream to the low-pressure gas turbine 9.

The waste heat boiler assembly 3 has a boiler inlet side 10 and a boiler outlet side 11. The boiler inlet side 10 is fluidically connected to a turbine exhaust 12 of the low-pressure gas turbine 9. The boiler outlet side 11 has a first boiler outlet 13 and a second boiler outlet 14. The first boiler outlet 13 is connected to an exhaust stack 15. The second boiler outlet 14 is connected to an inlet 16 of the exhaust gas recirculation duct 4. An outlet 17 of the exhaust gas recirculation duct 4 is fluidically connected to a compressor inlet 18 of the compressor 5. Therefore, the exhaust gas recirculation duct 4 connects the second boiler outlet 14 to the compressor inlet 18. In the example, an exhaust gas recirculation cooler 19 is arranged in the exhaust gas recirculation duct 4 and is preferably designed as a DCC device so that by means of the exhaust gas recirculation cooler 19 the recirculated exhaust gas can be cooled and at the same time scrubbed. DCC stands for direct contact cooler in this case.

In the embodiments shown here, the waste heat boiler assembly 3 has a first boiler exhaust gas path 20 which is indicated by an arrow in FIGS. 1 to 5. The first boiler exhaust gas path 20 is connected to the boiler inlet side 10 and leads to the first boiler outlet 13. The waste heat boiler assembly 3 also includes a second boiler exhaust gas path 21 which is also indicated by an arrow. The second boiler exhaust gas path 21 is also fluidically connected to the boiler inlet side 10 and leads to the second boiler outlet 14. In this case, the two boiler exhaust gas paths 20, 21 lead separately to the two boiler outlets 13, 14. For realization of the two boiler exhaust gas paths 20, 21 inside the waste heat boiler assembly 3, provision can be made for a boiler partition 22 which is arranged in the respective waste heat boiler assembly 3 for this purpose and in this case fluidically separates the two boiler exhaust gas paths 20, 21 from each other.

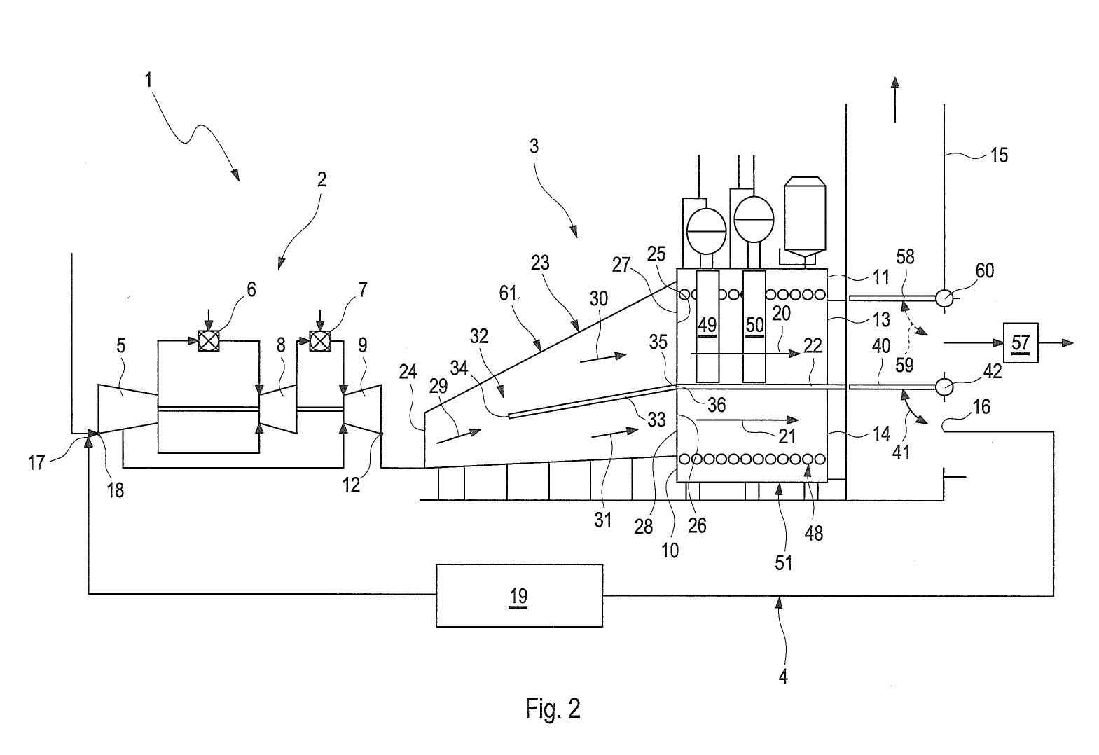

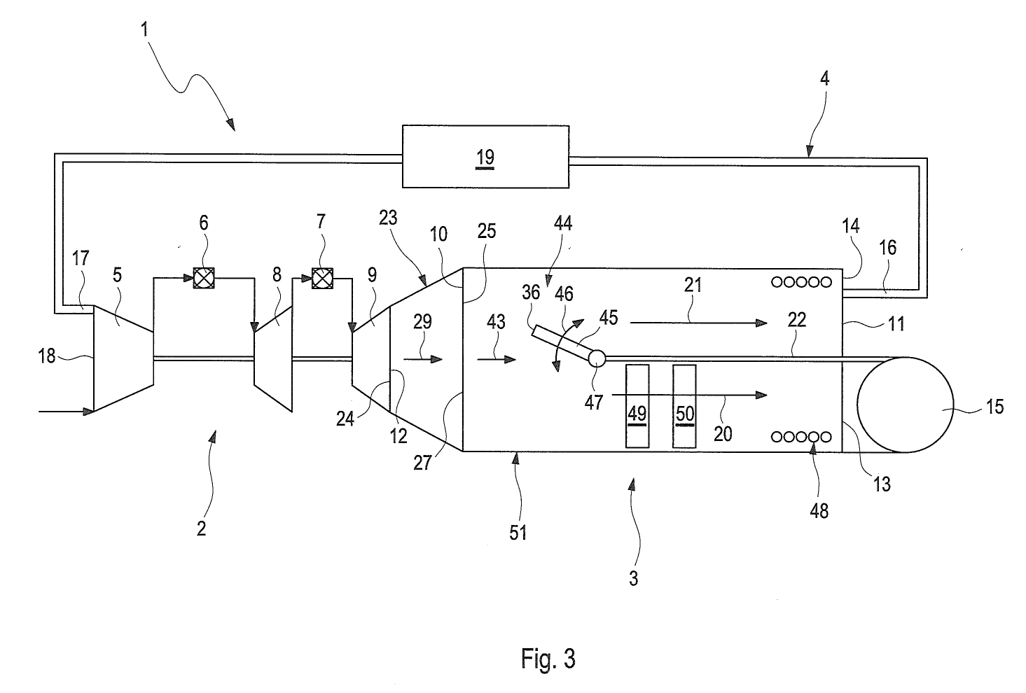

In the embodiments shown here, a diffuser 23 is arranged in each case on the boiler inlet side 10 and has a diffuser inlet 24 and at least one diffuser outlet 25, 26. In the embodiments of FIGS. 1 and 2, provision is made for two diffuser outlets, specifically a first diffuser outlet 25 and a second diffuser outlet 26. In contrast to this, in the embodiments of FIGS. 3-5 only a single common diffuser outlet 25 is provided. The diffuser inlet 24 is connected to the turbine exhaust 12.

In the embodiments of FIGS. 3 to 5, the common diffuser outlet 25 is fluidically connected to the boiler inlet side 10. In the embodiments of FIGS. 1 and 2, in contrast the first diffuser outlet 25 is fluidically connected to a first boiler inlet 27, whereas the second diffuser outlet 26 is fluidically connected to a second boiler inlet 28. The two boiler inlets 27, 28 are formed on the boiler inlet side 10 in this case. In the embodiments of FIGS. 1 and 2, the first boiler exhaust gas path 20 therefore leads from the first boiler outlet 27 to the first boiler outlet 13. In parallel and separately to this, the second boiler exhaust gas path 21 leads from the second boiler inlet 28 to the second boiler outlet 14.

Formed in the diffuser 23 in the embodiments shown in FIGS. 1 and 2 are a common diffuser main path 29, which is indicated by an arrow, and a first diffuser exhaust gas path 30, which is indicated by an arrow, and a second diffuser exhaust gas path 31, which is also indicated by an arrow. The common diffuser main path 29 branches at a diffuser branch point 32 into the two separate diffuser exhaust gas paths 30, 31. For realization of the two separate diffuser exhaust gas paths 30, 31, a diffuser partition 33 is arranged in a diffuser housing 61 of the diffuser 23. An inflow edge 34 of the diffuser partition 33 defines the diffuser branch point 32. The diffuser partition 33 separates the two diffuser exhaust gas paths 30, 31 from the diffuser branch point 32 up to the two diffuser outlets 25, 26. In the examples of FIGS. 1 and 2, the diffuser partition 33 and the boiler partition 22 are arranged so that an outflow edge 35 of the diffuser partition 33 and an inflow edge 36 of the boiler partition 22 butt against each other.

As a result of the mutually abutting partitions 22, 33, the first diffuser exhaust gas path 30 merges directly into the first boiler exhaust gas path 20, whereas at the same time the second diffuser exhaust gas path 31 merges into the second boiler exhaust gas path 21. In this way, a common first exhaust gas path 20-30, consisting of the first boiler exhaust gas path 20 and the first diffuser exhaust gas path 30, and a common second exhaust gas path 21-31, consisting of the second boiler exhaust gas path 21 and the second diffuser exhaust gas path 31, are formed inside the unit consisting of diffuser 23 and waste heat boiler assembly 3.

In the example of FIG. 1, a control element 37 which, corresponding to a double arrow 38, is pivotably adjustable around a pivot axis 39, is arranged at the diffuser branch point 32. By means of the control element 37, an apportioning of the exhaust gas flow to the two diffuser exhaust gas paths 30, 31 can be controlled.

In the embodiment shown in FIG. 2, such an inlet-side control element 37, which is arranged at the diffuser branch point 32, is omitted. To this end, in the embodiment shown in FIG. 2 another, outlet-side control element 40 is arranged on the boiler outlet side 11 and is pivotable around a pivot axis 42, corresponding to a double arrow 41. By means of this control element 40, an apportioning of the exhaust gas flow flowing through the second boiler exhaust gas path 21 to the exhaust gas recirculation duct 4 and the exhaust stack 15 can be controlled. In FIG. 1, it is shown that such an outlet-side control element 40 can also be provided cumulatively to the inlet-side control element 37 which is arranged at the diffuser branch point 32.

In the embodiments of FIGS. 3 to 5, the diffuser 23 includes no two separate diffuser exhaust gas paths 30, 31 but only a common, continuous diffuser main path 29. Also, the boiler inlet side 10 has only a common boiler inlet, which is also subsequently designated 27. Extending from this common boiler inlet 27 is a common boiler main path 43, indicated by an arrow, which splits into the two boiler exhaust gas paths 20, 21 at a boiler branch point 44. In the examples of FIGS. 3 to 5, an internal control element is arranged at this boiler branch point 44 and is adjustable around a pivot axis 47, corresponding to a double arrow 46. By means of this control element 45, an apportioning of the exhaust gas flow to the two boiler exhaust gas paths 20, 21 can be controlled.

The respective waste heat boiler assembly 3 comprises at least one heat exchanger assembly 48. The heat exchanger assembly 48 serves for cooling the exhaust gas and expediently operates with a cooling medium, e.g. water, which circulates in the heat exchanger assembly 48 with separation of the medium from the exhaust gas.

The two boiler exhaust gas paths 20, 21 are routed in parallel and separately through this heat exchanger assembly 48.

As can be gathered from FIGS. 2 to 5, inside the waste heat boiler assembly 3 at least one exhaust gas treatment device 49, 50 is arranged only in the first boiler exhaust gas path 20. Purely by way of example, two exhaust gas treatment devices 49, 50, specifically an inflow-side, first exhaust gas treatment device 49 and a second exhaust gas treatment device 50 arranged on the outflow side, are arranged in tandem in the first boiler exhaust gas path 20. Purely by way of example, the first exhaust gas treatment device is a CO catalyst, whereas the second exhaust gas treatment device 50 is a NOₓ catalyst. The at least one exhaust gas treatment device 49, 50 increases the flow resistance of the first boiler exhaust gas path 20, which simplifies flow guiding through the exhaust gas recirculation duct 4.

In the embodiments of FIGS. 1 to 3 and 5, the waste heat boiler assembly 3 is formed in each case by a single, common waste heat boiler 51. In this common waste heat boiler 51 are formed the two boiler exhaust gas paths 20, 21. In addition, this common waste heat boiler 51 has the respective boiler inlet 27, 28 and the respective boiler outlet 13, 14. Also, when a common waste heat boiler 51 is being used, provision is expediently made for a common heat exchanger assembly 48 through which both boiler exhaust gas paths 20, 21 are then in parallel and separately routed.

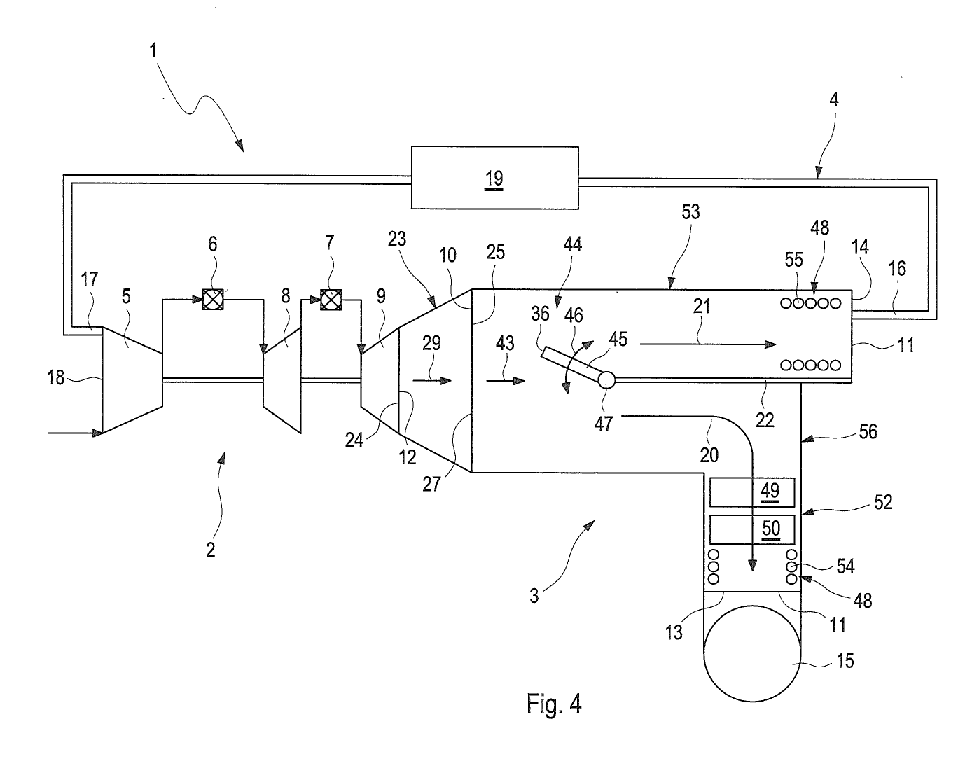

In contrast to this, FIG. 4 now shows a variant, in which the waste heat boiler assembly 3 has two separate waste heat boilers 52 and 53, specifically a first waste heat boiler 52 and a second waste heat boiler 53. The first boiler exhaust gas path 20 is formed in the first waste heat boiler 52, whereas the second boiler exhaust gas path 21 is formed in the second waste heat boiler 53. In this specific embodiment, the aforementioned heat exchanger assembly 48 comprises a first heat exchanger 54 and a second heat exchanger 55. The first heat exchanger 54 is arranged in the first waste heat boiler 52 and exposed to throughflow by the first boiler exhaust gas path 20. The second heat exchanger 55 is arranged in the second waste heat boiler 53 and exposed to throughflow by the second boiler exhaust gas path 21. In the example of FIG. 4, the two separate waste heat boilers 52, 53 are arranged in a common housing 56. In principle, however, an embodiment in which the two waste heat boilers 52, 53 have separate housings is also conceivable. In addition, FIG. 4 shows a specific embodiment in which the two waste heat boilers 52, 53 are arranged relative to each other so that the first boiler exhaust gas path 20 is inclined in relation to the longitudinal direction of the second boiler exhaust gas path 21, in the example by about 90°, at least in an end section leading to the exhaust stack 15.

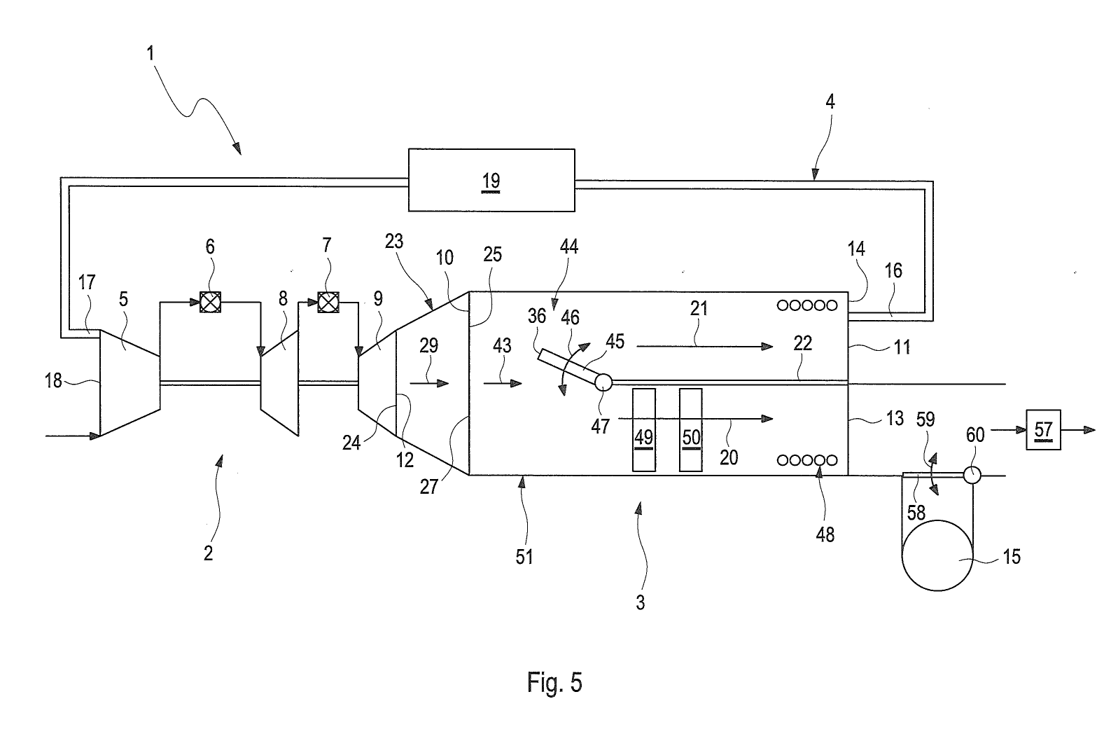

According to FIGS. 2 and 5, the first boiler outlet 13 can also be fluidically connected to an exhaust gas aftertreatment facility 57. In the case of this exhaust gas aftertreatment facility 57 it can be a CCS device, for example, which can separate and store carbon dioxide. CCS stands for carbon capture and storage in this case. Such an exhaust gas aftertreatment facility 57 can also be designed as a particulate filter, for example, by means of which soot particles entrained in the recirculated exhaust gas can be filtered out of the exhaust gas flow.

In the embodiments of FIGS. 2 and 5, provision is also made for an exhaust gas control element 58 which is adjustable around a pivot axis 60, according to a double arrow 59. By means of this exhaust gas control element 58, an apportioning of the exhaust gas flow of the first boiler exhaust gas path 20 to the said exhaust gas aftertreatment facility 57 and to the exhaust stack 15 can be controlled.

1. A gas turbine plant comprising:
at least one gas turbine installation which has at least one compressor, at least one burner and at least one gas turbine,
at least one waste heat boiler assembly which has a boiler inlet side connected to a turbine exhaust of the gas turbine installation, a first boiler outlet connected to an exhaust stack, and a second boiler outlet, and
an exhaust gas recirculation duct which connects the second boiler outlet to a compressor inlet of the gas turbine installation,
wherein the waste heat boiler assembly has a first boiler exhaust gas path which is connected to the boiler inlet side and leads to the first boiler outlet, and
wherein the waste heat boiler assembly has a second boiler exhaust gas path which is connected to the boiler inlet side and leads to the second boiler outlet separately from the first boiler exhaust gas path.

2. The gas turbine plant as claimed in claim 1, further comprising a boiler partition arranged in the waste heat boiler assembly and separates the two boiler exhaust gas paths from each other.

3. The gas turbine plant as claimed in claim 1, wherein the boiler inlet side has a common boiler inlet from which extends a common boiler main path which at a boiler branch point is divided into the two boiler exhaust gas paths.

4. The gas turbine plant as claimed in claim 3, further comprising a control element arranged at the boiler branch point for controlling an apportioning of the exhaust gas flow to the two boiler exhaust gas paths.

5. The gas turbine plant as claimed in claim 1, wherein the boiler inlet side has a first boiler inlet and a second boiler inlet,
the first boiler exhaust gas path leads from the first boiler inlet to the first boiler outlet, and
the second boiler exhaust gas path leads from the second boiler inlet to the second boiler outlet separately from the first boiler exhaust gas path, and further comprising:
a diffuser is arranged on the boiler inlet side and has a diffuser inlet connected to the turbine exhaust, a first diffuser outlet connected to the first boiler inlet and a second diffuser outlet connected to the second boiler inlet, and
a common diffuser main path extends from the diffuser inlet and at a diffuser branch point is divided into two diffuser exhaust gas paths which are separated from each other.

6. The gas turbine plant as claimed in claim 5, further comprising a diffuser partition arranged in the diffuser, the inflow edge of which forms the diffuser branch point and which separates the two diffuser exhaust gas paths up to the diffuser outlets.

7. The gas turbine plant as claimed in claim 2, further comprising an outflow edge of the diffuser partition and an inflow edge of the boiler partition butt against each other.

8. The gas turbine plant as claimed in claim 5, further comprising a control element arranged at the diffuser branch point for controlling an apportioning of the exhaust gas flow to the two diffuser exhaust gas paths.

9. The gas turbine plant as claimed in claim 1, wherein the waste heat boiler assembly has a heat exchanger assembly for cooling the exhaust gas; and
both boiler exhaust gas paths are routed separately through the heat exchanger assembly.

10. The gas turbine plant as claimed in claim 1, further comprising in the waste heat boiler assembly at least one exhaust gas treatment device arranged only in the first boiler exhaust gas path.

11. The gas turbine plant as claimed in claim 1, wherein the waste heat boiler assembly has a common waste heat boiler in which are formed the two boiler exhaust gas paths and which has the respective boiler inlet and also the respective boiler outlet.

12. The gas turbine plant as claimed in claim 11, wherein the waste heat boiler has a common heat exchanger assembly through which both boiler exhaust gas paths are routed.

13. The gas turbine plant as claimed in claim 1, wherein the waste heat boiler assembly has a first waste heat boiler in which is formed the first boiler exhaust gas path, and a second waste heat boiler in which is formed the second boiler exhaust gas path.

14. The gas turbine plant as claimed in claim 13, wherein a heat exchanger assembly having a first heat exchanger which is arranged in the first waste heat boiler and through which the first boiler exhaust gas path is routed, and a second heat exchanger which is arranged in the second waste heat boiler and through which the second boiler exhaust gas path is routed.

15. The gas turbine plant as claimed in claim 1, wherein the first boiler outlet is also connected to a exhaust gas aftertreatment facility; and
further comprising an exhaust gas control element provided for controlling an apportioning of the exhaust gas flow of the first boiler exhaust gas path to the exhaust gas aftertreatment facility and to the exhaust stack.
